(19) United States
(12) Patent Application Publication
(10) Pub. No.: US 2025/0017232 A1
(43) Pub. Date: Jan. 16, 2025

(54) SOFT SOLID FAT COMPOSITIONS AND METHODS OF MAKING AND USE THEREOF

(71) Applicant: CARGILL, INCORPORATED, Wayzata, MN (US)

(72) Inventors: April Rae PARKER, Plymouth, MN (US); Fernanda ZACCARELLI DAVOLI, Plymouth, MN (US)

(21) Appl. No.: 18/711,799

(22) PCT Filed: Nov. 8, 2022
(86) PCT No.: PCT/US2022/079481

§ 371 Date: May 20, 2024

Related U.S. Application Data
(60) Provisional application No. 63/282,783, filed on Nov. 24, 2021.

(51) Int. Cl. A23D 9/04; A21D 2/16; A23C 11/02; A23G 3/40

(52) U.S. Cl. CPC A23D 9/04; A21D 2/165; A23C 11/02; A23G 3/40

(57) ABSTRACT

Provided is a composition comprising a fat blend, wherein the fat blend comprises cottonseed stearin, wherein the composition has a solid fat content (SFC) at 20° C. of about 1% to about 65%, a SFC at 30° C. of 0% to about 40%, and a SFC at 40° C. of 0) % to 19.9%. The composition may be used in a food item. Methods of making the composition and food items including the composition are included.

### CROSS-REFERENCE TO RELATED APPLICATIONS

This application claims the benefit of U.S. Provisional Patent Application No. 63/282,783, filed Nov. 24, 2021, which is incorporated by reference herein in its entirety.

### FIELD

The present invention relates generally to fat compositions, including methods of making and uses thereof.

### BACKGROUND

Fat plays an important and multi-functional role in bakery products. The fat imparts structure development, richness, and tenderness to the product, which improves the eating qualities of the products. For some products like cake and icing, the fat helps provide aeration. For Danish or puff pastry, fat can help provide for the development of flakiness in the product or for other products it can lubricate the gluten. Fat is extremely important in the creaming process (e.g., the combining of fat with other ingredients into a batter or dough), because it helps entrap air which leads to a leavening effect in cakes or a desired volume in icings. Liquid oil does not function the same way and cannot be used in all bakery products. The structure provided from a more solid fat is necessary to deliver on expected quality of bakery products.

Various approaches have been developed to make bakery shortenings without using palm oil. One approach is to use tropical or exotic fats such as cocoa butter, coconut oil, shea butter; however, those alternatives are very expensive and can require supply chain development. Another approach is the use of oleogels, which contains gelators (e.g., materials such as vegetable waxes, emulsifiers, polymers or starch) to add structure to liquid oil. Unfortunately, in general, oleogels lack functionality and are very difficult to be produced at large scale, and usually the materials used (gelators) are not label-friendly.

### SUMMARY

The present technology provides a composition that includes a fat blend, wherein the fat blend comprises cottonseed stearin, wherein the fat blend has a solid fat content (SFC) at 20° C. of about 1% to about 65%, a SFC at 30° C. of 0% to about 40%, and a SFC at 40° C. of 0% to 19.9%. In any aspect, the fat blend may have a SFC at 10° C. of about 18% to about 70%.

In any aspect, the fat blend may be an interesterified fat blend. In any aspect, the fat blend may be homogenous.

The present technology also provides a food item that includes the composition disclosed herein.

In another aspect, the technology provides a method of making the composition disclosed herein, the method including combining cottonseed stearin and other edible components to form a homogenous mixture. In some aspects, the method may further include interesterifying the homogenous mixture.

The present technology provides certain advantages over other alternative fat compositions and food items including the same. For example, there is a clear demand from the food industry to the oil and fat producers to develop alternatives for palm oil, especially for sustainability reasons. Often, the composition or food item of the present technology is substantially free of palm oil, which is beneficial for sustainability purposes.

The mechanical properties and physical structure of a fat are responsible for its functionality and affect the quality of food items made therewith. The composition of the present technology has properties and structure (e.g., properties and structure similar to palm oil-based fat products) such that it can be utilized as an alternative fat in a wide variety of food items.

In some aspects, the composition of the present technology provides a composition, preferably a substantially palm oil-free composition, that does not rely on the addition of synthesized additives (e.g., emulsifiers, waxes, and the like) or non-lipid materials (e.g., starch, protein, ethyl cellulose, and the like) to provide the properties and structure needed for functionality of the fat replacement and for the quality of food items made therewith. In some aspects, the composition of the present technology is an alternative fat that is preferably not palm, not hydrogenated, not exotic or tropical, is pure lipid-based, and is provided from a well-established and sustainable supply chain.

The foregoing summary is illustrative only and is not intended to be in any way limiting. In addition to the illustrative aspects, aspects and features described above, further aspects, aspects and features will become apparent by reference to the following detailed description.

### DETAILED DESCRIPTION

In the following detailed description, reference is made to the accompanying drawings, which form a part hereof. In the drawings, similar symbols typically identify similar components, unless context dictates otherwise. The illustrative aspects described in the detailed description, drawings, and claims are not meant to be limiting. Other aspects may be utilized, and other changes may be made, without departing from the spirit or scope of the subject matter presented here.

The following terms are used throughout as defined below. All other terms and phrases used herein have their ordinary meanings as one of skill in the art would understand.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, “substantially free” refers to less than about 2 wt % of the specified component based on the total weight of the composition. In any aspect, the composition may include less than about 1 wt %, less than about 0.5 wt %, or less than about 0.1 wt % of the specified component. In any aspect, the composition may free of the specified component.

As used herein, “homogenous” refers to a mixture that is substantially uniform or uniform.

As used herein, the term “solid fat” or “solid fat content” or “SFC” refers to the percent of crystalized solid fat present over a defined temperature scale. SFC may be measured by methods known to persons of ordinary skill in the art: for example, the SFC may be determined via nuclear magnetic resonance (NMR) (See AMERICAN OIL CHEMIST SOCIETY Official Methods and Recommended Practices, 6th ed., 2008, AOCS Official Method cd-16b-93, which is incorporated herein by reference).

As used herein, “triglyceride” refers to a molecule having a glycerol moiety that is linked to three fatty acid residues via ester bonds. A “fatty acid residue” is a fatty acid in its acyl or esterified form. The term “fatty acid” as used herein can refer to a molecule comprising a hydrocarbon chain and a terminal carboxylic acid group. Alternatively, the carboxylic acid group may be in the free fatty acid or salt form (i.e., COO″ or COOH). The ‘tail’ or hydrocarbon chain of a fatty acid may also be referred to as a fatty acid chain, fatty acid sidechain, or fatty chain. The hydrocarbon chain of a fatty acid will typically be a saturated or unsaturated aliphatic group. A fatty acid having n number of carbons, will typically have a fatty acid side chain having n-1 carbons. Non-limiting examples of fatty acids include C8, C10, C12, C14, C16 (e.g., C16:0, C16:1), C18 (e.g., C18:0, C18:1, C18:2, C18:3, C18:4), C20, and/or C22 fatty acids. For example, the fatty acids can be caprylic (8:0), capric (10:0), lauric (12:0), myristic (14:0), palmitic (16:0), stearic (18:0), oleic (18:1), linoleic (18:2), linolenic (18:3) acid, or a combination of two or more thereof.

As used herein, the term “edible component(s)” refers to fats, oils, and/or additives (e.g., antioxidants, colors, flavors, emulsifiers, etc.) that are suitable for human consumption.

As used herein, the term “flaked fat” refers to a fat with the properties that allow it to be flaked, but it not necessarily in a flaked form. To flake a fat, a fat blend is melted at about 10-15° F. above the fat's melting point and distributed on a stainless steel belt or drum cooled by glycol. As the fat is moved down the belt or over the drum, it is crystalized into a hardened form. The fat is then scrapped off the belt or drum and broken into smaller pieces (i.e., fat flakes). A flaked fat behaves as a solid at room temperature. When added to a food item, a flaked fat can help in lamination and crispness of the product.

The present technology provides a composition that includes a fat blend, wherein the fat blend comprises cottonseed stearin, wherein the fat blend has a solid fat content (SFC) at 20° C. of about 1% to about 65%, a SFC at 30° C. of 0% to about 40%, and a SFC at 40° C. of 0% to 19.9%. In any aspect, the fat blend may have a SFC at 10° C. of about 18% to about 70%.

In any aspect, the fat blend may have a SFC at 10° C. of about 20% to about 65% including about 30% to about 60%, about 30% to about 55%, or about 35% to about 55%.

In some aspects, the fat blend may have a SFC at 20° C. of about 1% to about 55% including about 1% to about 45%, about 1% to about 35%, or about 4% to about 22%.

In some aspects, the fat blend may have a SFC at 30° C. of 0% to about 30% including 0% to about 25%, 0% to about 15%, or 0% to about 7%.

In any aspect, the fat blend may have a SFC at 40° C. of less than 20%. In any aspect, the fat blend may have a SFC at 40° C. of 0% to about 18% including 0% to about 15%, 0% to about 12%, or 0% to about 5%.

In any aspect, the SFC percent may decrease as the temperature decreases.

Cottonseed stearin is the solid component of cottonseed oil that can be separated from the cottonseed oil. Cottonseed includes components that melt at higher temperatures (the stearin) and lower temperatures (the olein). Herein, the cottonseed stearin can be any suitable cottonseed stearin. In any aspect, the cottonseed stearin may be cottonseed stearin from a first fractionation, cottonseed stearin from a second fractionation, cottonseed stearin from more than a second fractionation, cottonseed stearin from one or more winterization fractionations, or a combination of two or more thereof.

In some aspects, the fat blend may be a non-interesterified fat blend.

In some aspects, the fat blend may be an interesterified fat blend. Interesterification is a method of rearranging and redistributing the fatty acid on the glycerol fragment of an oil molecule. The rearrangement and redistribution does not change the overall composition of the fatty acids on the starting materials.

In any aspect, the interesterified fat blend may be chemically interesterified. Chemical interesterification is a process by which fatty acids are randomly redistributed across the glycerol backbone of the triglyceride. This process is carried out by drying the starting material and adding an interesterification catalyst, such as sodium methoxide, or another acid or base catalyst. When the reaction is complete, the catalyst is neutralized. The rearranged product can be washed, bleached, and/or deodorized. The rearranged product can have different physical-chemical properties than the starting material.

In any aspect, the interesterified fat blend may be enzymatically interesterified. Enzymatic interesterification is another means by which oils and fats can be modified. This process uses most commonly, immobilized lipases to rearrange the fatty acids on the glycerol backbone of the triglyceride. There are immobilized lipases that can target fatty acids at specific positions on the glycerol backbone, therefore, the rearrangement of fatty acids during such an enzymatic interesterification can be less random than with chemical interesterification. After interesterification, the material may be deodorized to make finished interesterified material. Enzymatic interesterification has gained popularity over the last decades due to the flexibility of the process and reduced capital process input.

The interesterification can be performed to any suitable extent between the arrangement and distribution of the fatty acids in the starting materials versus the steady-state arrangement and distribution of the fatty acids obtained when the interesterification is allowed to run to substantial completion. In various aspects, the interesterified fat blend may be a fat blend that has been chemically interesterified to substantial completion at which point it has reached a relatively steady-state arrangement and distribution of the fatty acids on the glycerol units of the material.

Any suitable proportion of the composition can be the fat blend, such as 0.01 wt % to 100 wt % including about 25 wt % to about 99 wt %, or about 0.01 wt % or more but less than or equal to 100 wt %, or 0.01 wt % to 100 wt % and less than, equal to, or greater than 0.05 wt %, 0.1, 0.2, 0.4, 0.6, 0.8, 1, 1.5, 2, 2.5, 3, 4, 5, 6, 8, 10, 12, 14, 16, 18, 20, 25, 30, 35, 40, 45, 50, 55, 60, 65, 70, 75, 80, 82, 84, 86, 88, 90, 92, 94, 95, 96, 97, 98, 99, 99.9 wt %, or 99.99 wt % 99.99 wt % or less of the composition, or any range including and/or in between any two of the preceding values.

Any suitable proportion of the fat blend can be the cottonseed stearin, such as 0.01 wt % to 100 wt % including about 25 wt % to about 99 wt %, about 25 wt % to about 75 wt %, about 25 wt % to about 45 wt %, about 40 wt % to about 60 wt %, about 55 wt % to about 75 wt %, or about 0.01 wt % or more but less than or equal to 100 wt %, or 0.01 wt % to 100 wt % and less than, equal to, or greater than 0.05 wt %, 0.1, 0.2, 0.4, 0.6, 0.8, 1, 1.5, 2, 2.5, 3, 4, 5, 6, 8, 10, 12, 14, 16, 18, 20, 25, 30, 35, 40, 45, 50, 55, 60, 65, 70, 75, 80, 82, 84, 86, 88, 90, 92, 94, 95, 96, 97, 98, 99, 99.9 wt %, 99.99 wt % or less of the fat blend, or any range including and/or in between any two of the preceding values.

The composition or fat blend can be substantially free of palm oil including a fraction thereof, a high oleic version thereof, a hydrogenated oil formed therefrom, an interesterified oil formed therefrom, or a combination thereof. For example, the composition or fat blend can include 0 wt % palm oil, or less than 5 wt % palm oil, or less than 4.5%, 4, 3.5, 3, 2.5, 2, 1.5, 1, 0.8, 0.6, 0.5, 0.4, 0.3, 0.2, 0.1, 0.05 wt %, or less than 0.01 wt % palm oil, or any range including and/or in between any two of the preceding values.

In any aspect, the composition or fat blend can be substantially free of fully hydrogenated oils. As used herein, a fully hydrogenated oil is an oil having an iodine value equal to or less than 4. For example, the composition of fat blend can include 0 wt % fully hydrogenated oils, or less than 5 wt % fully hydrogenated oils, or less than 4.5%, 4, 3.5, 3, 2.5, 2, 1.5, 1, 0.8, 0.6, 0.5, 0.4, 0.3, 0.2, 0.1, 0.05 wt %, or less than 0.01 wt % fully hydrogenated oils, or any range including and/or in between any two of the preceding values. In any aspect, the composition or fat blend can include one or more fully hydrogenated oils. As used herein, a fully hydrogenated oil is an oil having an iodine value equal to or less than 4. For example, the composition of fat blend can include more than 0 wt % fully hydrogenated oils, or more than 5 wt % fully hydrogenated oils, or more than 8%, 10, 12, 14, 16, 18, 20, 22, 24, 26, 28, 29, 30, 32, 34, 36, 38, 40, 42, 44, 46, 48, 48 wt %, or more than 50 wt % fully hydrogenated oils, or any range including and/or in between any two of the preceding values. For example, the composition of fat blend can include less than 100 wt % fully hydrogenated oils, or less than 99.9 wt % fully hydrogenated oils, or less than 99.5%, 99, 98, 96, 94, 92, 90, 88, 86, 84, 82, 80, 78, 76, 74, 72, 70, 68, 66, 64, 62, 60, 58, 56, 55, 54, 53, 52, 51, 50, 49, 48, 47, 46, 45, 44, 43, 42, 41, 40, 39, 38, 37 wt %, or less than 36 wt % fully hydrogenated oils, or any range including and/or in between any two of the preceding values.

In other aspects, the composition or fat blend may include a fully hydrogenated oil (e.g., a fully hydrogenated cottonseed oil having an iodine value equal to or less than 4).

In some aspects, the composition or fat blend may include one or more plant-based oils in addition to the cottonseed stearin. Plant-based oils other than the cottonseed stearin may be any suitable plant-based oil, such as coconut oil, corn oil, canola oil, cottonseed oil, olive oil, palm oil, peanut oil, rapeseed oil, safflower oil, sesame oil, soy bean oil, sunflower oil, jojoba oil, cocoa butter, shea butter, mango butter, babassu oil, cupuassu oil, macauba oil, bacuri oil, tucuma oil, kokum oil, ucuuba oil, licuri oil, pequi oil, Illipe oil, a fraction thereof, a middle or high oleic version thereof, a low linolenic version thereof, a low saturated version thereof, a hydrogenated oil formed therefrom (e.g. partially or fully hydrogenated), an interesterified oil formed therefrom, or a combination thereof. The one or more plant-based oils other than the cottonseed stearin can form any suitable proportion of the fat blend, such as 0.01 wt % to 99.99 wt % of the fat blend, 10 wt % to 90 wt %, or 0.01 wt % or more but less than or equal to 99.99 wt %, or 0.01 wt % to 99.99 wt % and less than, equal to, or greater than 0.05, 0.1, 0.2, 0.4, 0.6, 0.8, 1, 1.5, 2, 2.5, 3, 4, 5, 6, 8, 10, 12, 14, 16, 18, 20, 25, 30, 35, 40, 45, 50, 55, 60, 65, 70, 75, 80, 82, 84, 86, 88, 90, 92, 94, 95, 96, 97, 98, 99, 99.9 wt %, 99.99 wt % %, or any range including and/or in between any two of the preceding values.

In some aspects, the composition or fat blend can be substantially free of emulsifiers, non-cottonseed waxes, starch, protein, cellulose, cellulose derivatives, plant-based oils other than cottonseed stearin, or a combination of two or more thereof. For example, the composition or fat blend can include 0 wt % of any one or more of these components, or less than 5 wt %, or less than 4.5%, 4, 3.5, 3, 2.5, 2, 1.5, 1, 0.8, 0.6, 0.5, 0.4, 0.3, 0.2, 0.1, 0.05 wt %, or less than 0.01 wt % of any one or more of these components, or any range including and/or in between any two of the preceding values. In other aspects, the composition or fat blend can include emulsifiers, non-cottonseed waxes, starch, protein, cellulose, cellulose derivatives, plant-based oils other than cottonseed stearin, or a combination of two or more thereof.

In some aspects, the composition or fat blend can include an emulsifier, a wax (e.g., a non-cottonseed stearin derived wax, or a cottonseed stearin derived wax), a carbohydrate (e.g., starch), a protein, cellulose, a cellulose derivative (e.g., ethyl cellulose), a food coloring, a filler (e.g., fibers), a flavoring, a plant-based oil other than interesterified cottonseed stearin, an animal-based oil (e.g., lard, tallow, milk fat, and the like), or a combination of two or more thereof. The composition or fat blend can include an interesterified oil other than cottonseed stearin (e.g., interesterified plant-based oils other than the cottonseed stearin), a fully hydrogenated oil (e.g., fully hydrogenated cottonseed oil), a polysorbate, a monoglyceride, a diglyceride, or a combination of two or more thereof.

In any aspect, the composition may include one or more animal-based oils.

In any aspect, the fat blend may include 0 wt % to about 35 wt % C12:0 fatty acid, about 15 wt % to about 60 wt % C16:0 fatty acid, about 1 wt % to about 50 wt % C18:0 fatty acid, about 5 wt % to about 20 wt % C18:1 fatty acid, about 10 wt % to about 40 wt % C18:2 fatty acid, 0 wt % to about 5 wt % C18:3 fatty acid, or a combination of two or more thereof. In any aspect, the fat blend may include 0 wt % to about 30 wt % C12:0 fatty acid, about 15 wt % to about 45 wt % C16:0 fatty acid, about 1 wt % to about 40 wt % C18:0 fatty acid, about 5 wt % to about 15 wt % C18:1 fatty acid, about 15 wt % to about 35 wt % C18:2 fatty acid, 0 wt % to about 3 wt % C18:3 fatty acid, or a combination of two or more thereof.

Any suitable proportion of the fat blend can be C12:0 fatty acid esters (i.e., proportion of the total fatty acids on glycerol units) that are C12:0 fatty acids, such as 0 wt % to 35 wt %, 0 wt % to 1 wt %, or 0 wt % or more but less than or equal to 30 wt %, or less than, equal to, or greater than 0.1 wt %, 5, 10, 15, 16, 17, 18, 19, 20, 21, 22, 23, 24, 25, 26, 27, 28, 29 wt %, 30 wt %, or any range including and/or in between any two of the preceding values.

Any suitable proportion of the fat blend can be C16:0 fatty acid esters (i.e., proportion of the total fatty acids on glycerol units) that are C16:0 fatty acids, such as 15 wt % to 60 wt %, 15 wt % to 45 wt %, or 15 wt % or more but less than or equal to 45 wt %, or less than, equal to, or greater than 15 wt %, 16, 17, 18, 19, 20, 21, 22, 23, 24, 25, 26, 27, 28, 29, 30, 31, 32, 33, 34, 35, 36, 37, 38, 39 wt %, 40 wt %, or any range including and/or in between any two of the preceding values.

Any suitable proportion of the fat blend can be C18:0 fatty acid esters, such as 1 wt % to 50 wt %, 1 wt % to 40 wt %, or 1 wt % or more but less than or equal to 35 wt %, or less than, equal to, or greater than 1, 2, 3, 4, 5, 6, 8, 10, 11, 12, 13, 14, 15, 16, 17, 18, 20, 22, 24, 25, 26, 27, 28, 29 wt %, 30 wt %, or any range including and/or in between any two of the preceding values.

Any suitable proportion of the fat blend can be C18:1 fatty acid esters, such as 5 wt % to 20 wt %, 5 wt % to 17 wt %, or 5 wt % or more but less than or equal to 15 wt %, or less than, equal to, or greater than 5, 6, 7, 8, 9, 10, 11, 12, 13, 14 wt %, 15 wt %, or any range including and/or in between any two of the preceding values.

Any suitable proportion of the fat blend can be C18:2 fatty acid esters, such as 10 wt % to 40 wt %, 15 wt % to 37 wt %, or 16 wt % or more but less than or equal to 35 wt %, or less than, equal to, or greater than 35 wt %, 17, 18, 19, 20, 21, 22, 23, 24, 25, 26, 27, 28, 29, 30, 31, 32, 33 wt %, 34 wt %, or any range including and/or in between any two of the preceding values.

Any suitable proportion of the fat blend can be C18:3 fatty acid esters, such as 0 wt % to 5 wt %, 0 wt % to 3 wt %, or 0 wt % or more but less than or equal to 2 wt %, or 0 wt % to 1 wt % and less than, equal to, or greater than 0.01 wt %, 0.05, 0.09, 0.1, 0.12, 0.15, 0.2, 0.25 wt %, 0.3 wt %, or any range including and/or in between any two of the preceding values.

Any suitable proportion of the fat blend can be saturated fatty acid esters, such as 25 wt % to 60 wt %, 30 wt % to 50 wt %, or 30 wt % or more but less than or equal to 60 wt %, or 30 wt % to 60 wt % and less than, equal to, or greater than 35 wt %, 40, 41, 42, 43, 44, 45, 46, 47, 48, 49, 50, 55 wt %, 60 wt %, or any range including and/or in between any two of the preceding values.

The composition or fat blend can have suitable properties for replacing other fats in food items or in the preparation of food items, such as providing appropriate structure (e.g., hardness) and/or other functionality to enable production of a food item of comparable or improved quality to a food item prepared from conventional or palm oil-based fats.

In any aspect, the composition or fat blend can have any suitable melting point, such as about 20° C. to about 60° C., about 25° C. to about 50° C., or about 20° C. or more but less than or equal to about 60° C., or less than, equal to, or greater than about 26° C., 28, 30, 32, 34, 36, 38, 40, 41, 42, 43, 44, 46, 48, 50, 52, 54, 56, 58° C., 60° C., or any range including and/or in between any two of the preceding values.

In any aspect, the composition or fat blend can have any suitable main melting point, such as below about 50° C., or above about 46° C., 45, 44, 43, 42, 41, 40, 35, 30, 29, 28, 27, 26, 25, 24, 23, 22, 21, 20, 19, 18, 17, 16, or 15° C., or any range including and/or in between any two of the preceding values. In any aspect, the composition or fat blend can have any suitable main melting point, such as above about 1° C., or below about 5° C., 6, 7, 8, 9, 10, 11, 12, or 13° C., or any range including and/or in between any two of the preceding values.

In any aspect, the composition or fat blend can have any suitable onset crystallization point as determined via DSC, such as −5° C. to about 40° C., about 0° C. to about 35° C., about 2° C. to about 30° C., or above about 3° C., 4, 5, 6, 7, 8, 9, 10° C., or below about 29° C., 28, 27, 26, 25, 24, 23, 22, 21, 20, or 19° C., or any range including and/or in between any two of the preceding values.

In any aspect, the fat blend may be homogenous.

In any aspect, the composition may be a frying fat.

In any aspect, the composition may be a biscuit filling, an icing, a frosting, a confectionary item, a bonbon filling, a chocolate or nut spreads, a margarine or spread (water in oil emulsion), bouillon, or a combination thereof.

In any aspect, the composition may be a shortening, an all-purpose shortening, an icing shortening, a filling fat, a frying fat, a pumpable shortening, a cookie shortening, a cake shortening, a pastry shortening, a pie shortening, or a combination of two or more thereof.

In any aspect, the composition may be a flaked fat.

The composition can be a filling (e.g., for a biscuit or a cookie). The composition can be 15 wt % to 75 wt % of the biscuit filling, or 25 wt % to 60 wt %, or 15 wt % or more but less than or equal to 75 wt %, or 15 wt % to 75 wt % and less than, equal to, or greater than 20 wt %, 25, 30, 35, 40, 45, 50, 55, 60, 65, 70 wt %, 75 wt %, or any range including and/or in between any two of the preceding values. The biscuit filling can include sugar: for example, sugar can be 40 wt % to 80 wt % of the biscuit filling, or 40 wt % or more but less than or equal to 80 wt %, or 40 wt % to 80 wt % and less than, equal to, or greater than 45 wt %, 50, 55, 60, 65, 70, 75 wt %, 80 wt %, or any range including and/or in between any two of the preceding values. The biscuit filling can include salt, vanilla, emulsifier, flavoring, coloring, cocoa powder, or a combination thereof.

The composition can be an icing shortening (e.g., for forming an icing or frosting such for a cake). The composition can be 0.1 wt % to 99 wt % of icing shortening, or 40 wt % to 97 wt %, or 0.1 wt % or more but less than or equal to 99 wt %, or 0.1 wt % to 99 wt % and less than, equal to, or greater than 1 wt %, 2, 5, 10, 15, 20, 25, 30, 35, 40, 45, 50, 55, 60, 65, 70, 75, 80, 85, 90, 95, 96, 97, 98 wt %, 99 wt %, or any range including and/or in between any two of the preceding values. The icing shortening can include one or more emulsifiers: for example, the one or more emulsifiers can be 0.01 wt % to 10 wt % of the composition, or 0.01 wt % or more, or less than, equal to, or greater than 0.5 wt %, 1, 2, 4, 6, 8 wt %, 10 wt %, or any range including and/or in between any two of the preceding values.

The composition can be an all-purpose shortening. The composition can be 0.1 wt % to 100 wt % of the all-purpose shortening, or 10 wt % to 100 wt %, or 0.1 wt % or more but less than or equal to 100 wt %, or 0.1 wt % to 100 wt % and less than, equal to, or greater than 1 wt %, 2, 4, 6, 8, 10, 15, 20, 25, 30, 35, 40, 45, 50, 55, 60, 65, 70, 75, 80, 85, 90, 95, 96, 97, 98, 99, 99.5, 99.9 wt %, 100 wt %, or any range including and/or in between any two of the preceding values. The all-purpose shortening can include one or more animal-based oils and/or plant-based oils other than the cottonseed stearin, such as 1 wt % to 90 wt %, or 1 wt % or more but less than or equal to 90 wt %, or 1 wt % to 90 wt % and less than, equal to, or greater than 5 wt %, 10, 15, 20, 25, 30, 35, 40, 45, 50, 55, 60, 65, 70, 75, 80, 85 wt %, 90 wt %, or any range including and/or in between any two of the preceding values. In some aspects, the all-purpose shortening can include soy bean oil. In some aspects, the all-purpose shortening can include a fully hydrogenated oil (e.g., an oil having an iodine value equal to or less than 4), such as a fully hydrogenated cottonseed oil.

In any aspect, the composition can be any suitable composition for replacing fat used in a food item and/or for replacing fat used in preparing a food item. In any aspect, the composition can be used to partially or completely replace other fats in food items. In any aspect, the composition can provide the properties and structure needed to replace other fats in a wide variety of food items.

The present technology also provides a food item that includes the composition disclosed herein. The food item can be any suitable food item that includes the composition, such as a food item including the fat composition as a partial or complete replacement for another fat composition (e.g., a palm oil-based fat composition). In any aspect, the food item can include a fried food item, a bakery food item, a biscuit filling, an icing, a frosting, a confectionary item, a bonbon filling, an ice-cream coating, a chocolate or nut spreads, a margarine or spread (water in oil emulsion), bouillon, or a combination thereof. The food item can include a potato chip, a French fry, a fried-chicken product, a tempura product, a biscuit, a cookie, a pie, a cake, a wafer, a filling, a dough, a glaze, a pastry, a donut, an icing, a frosting, a pizza crust, an American style biscuit, a chewing gum, a meat alternative, a dairy analog product (e.g., a non-dairy or reduced-dairy substitute product for a dairy product), ice cream, caramel, toffee, or a combination thereof. In any aspect, the food item may include a bakery food item a confectionary item, an ice-cream coating, a stabilizer (e.g., a stabilizer to delay the separation of a product and/or a heat stabilizer for increasing the melting point of a fat or composition), emulsifiers (e.g., can be used as a substitute for or used in addition to a palm stearin or palm super stearin emulsifier), a chocolate or nut spread, a margarine or spread (water in oil emulsion), bouillon, or a combination of two or more thereof. In any aspect, the food item may include a fried food item, a biscuit filling, an icing, a frosting, a bonbon filling, or a combination of two or more thereof.

In some aspects, the food item can be substantially free of palm oil (i.e., both the composition herein and the remainder of the food item are substantially free of palm oil). In other aspects, the composition, the remainder of the food item, or a combination thereof, may include at least some palm oil.

In any aspect, the food item can include about 0.01 wt % to about 99 wt % of the composition provided herein. In any aspect, the food item can include about 0.1 wt % to about 90 wt % of the composition, 1 wt % to 90 wt %, or 0.01 wt % or more but less than or equal to 99 wt %, and less than, equal to, or greater than 0.05, 0.1, 0.2, 0.4, 0.6, 0.8, 1, 1.5, 2, 2.5, 3, 4, 5, 6, 8, 10, 12, 14, 16, 18, 20, 25, 30, 35, 40, 45, 50, 55, 60, 65, 70, 75, 80, 82, 84, 86, 88, 90, 92, 94, 95, 96, 97, 98, 99, 99.9 wt %, 99.99 wt %, or any range including and/or in between any two of the preceding values.

In another aspect, the present technology provides a method of making the composition provided herein, the method including combining cottonseed stearin and other edible components to form a homogenous mixture. The combining can be performed in any suitable way. The combining can include melting the cottonseed stearin and blending the other edible components therewith.

In some aspects, the method may include interesterifying the homogenous mixture. In some aspects, the method may include further processing such as hydrogenation and/or fractionation. In some aspects, the method may include crystallizing the homogenous mixture. In some aspects, the method may include mechanical working such as kneading the crystallized mixture.

The present technology also provides a method of making a food item that includes the composition provided herein. The method can be any suitable method that forms a food item including the composition.

In another aspect, the present technology provides a use of the composition provided herein in partial or complete replacement of a fat in a food item and/or to form the food item. In any aspect, the use can be to form a food item.

Among others at least some of the advantages of the composition of the present technology resides in it providing a viable non-palm alternative for a food item. The thus produced food item has the right consistency.

The examples herein are provided to illustrate advantages of the present technology and to further assist a person of ordinary skill in the art with preparing or using the compositions of the present technology. The examples herein are also presented in order to more fully illustrate the preferred aspects of the present technology. The examples should in no way be construed as limiting the scope of the present technology, as defined by the appended claims. The examples can include or incorporate any of the variations or aspects of the present technology described above. The variations or aspects described above may also further each include or incorporate the variations of any or all other variations or aspects of the present technology.

### Examples

### Example 1: Fat blends

Cotton stearin (CS), double fractionated cotton stearin (DFCS), fully hydrogenated cottonseed oil (FHCO), and coconut oil (CO) were used in the exemplary fat blends. CS, DFCS, FHCO, and CO have the characteristics provided in Table 1.

TABLE 1
Solid fat content (SFC), melting point, fatty acid profile (FAP),
and saturated fatty acid of CS, DFCS, FHCO, and CO

| | | Double | | |
|---|---|---|---|---|
| | | fractionated | Fully | |
| | Cottonseed | cottonseed | hydrogenated | Coconut |
| | stearin | stearin | cottonseed oil | oil |
| | (CS) | (DFCS) | (FHCO) | (CO) |
| SFC (%) at 10° C. | 19.3 | 43.9 | 98.1 | 81.3 |
| SFC (%) at 20° C. | 1.0 | 19.6 | 97.4 | 39.9 |
| SFC (%) at 30° C. | 0 | 2.1 | 96.9 | 0.10 |
| SFC (%) at 40° C. | 0 | 0 | 96.4 | 0.20 |
| Melting point, ° C. | NA | 29.7 | 65.0 | 31.1 |
| FAP, C12:0, % | 0.01 | 0.01 | 0.05 | 45.8 |
| FAP, C16:0, % | 30.1 | 42.1 | 25.0 | 9.80 |
| FAP, C18:0, % | 2.4 | 2.0 | 72.6 | 3.70 |
| FAP, C18:1, % | 16.2 | 13.6 | 0.10 | 7.20 |
| FAP C18:2, % | 49.2 | 40.6 | 0.40 | 1.80 |
| FAP, C18:3, % | 0.2 | 0.2 | nd | 0.05 |
| Saturated FA, % | 33.6 | 45.1 | 99.5 | 90.9 |

CS, DFCS, FHCO, and/or CO were combined to provide fat blends 1-3 in Table 2. For each fat blend, the respective fat(s) were heated to 10-15° F. above their melting point, the respective oil(s) were added, and the mixture was blended until homogenous. Fat blends 1-3 were then interesterified following the same method to provide fat blends 4-6 in Table 2. To interesterify a fat blend, the initial fat blend was dried under vacuum (200 mbar, 110° C., 30 min under agitation). The vacuum was broken to add a catalytic amount (0.1% w/w) of sodium methoxide (anhydrous). Next, the reaction was started under vacuum (100 mbar) and continued for 30 min. The vacuum was released, followed by the addition of a 50% citric acid solution to inactivate the sodium methoxide (5-10 min of agitation). The mixture was then post bleached with 1.25% activated bleaching clay (200 mbar, 110° C., 30 min under agitation). The bleaching clay was removed by filtration over a preheated Buchner filter. After bleaching, the interesterified fat mixture was deodorized. Deodorization was completed by initially heating the material to 240° C. under vacuum (<1 torr). Once the target temperature was achieved, steam stripping via a heated water addition flask was conducted for 1 hour (5% water addition to generate steam for 1 hour). The water feed to the steam flask was then stopped and the interesterified fat mixture was cooled to 110° C. under vacuum. After reaching target temperature, a nitrogen overlay was added as vacuum was released and the interesterified fat blend was pulled from the reactor flask. Fat blend 7 was prepared following the same procedures.

The crystallization and melting profiles were determined for fat blends 1-7 as provided in Table 3.

TABLE 2
Solid fat content (SFC), melting point, fatty acid profile (FAP), and saturated fatty acid content of fat blends

| | Blend | Blend | Blend | CIE | CIE | CIE | CIE |
|---|---|---|---|---|---|---|---|
| | 35% CS + | 65% CS + | 50% DFCS + | 35% CS + | 65% CS + | 50% DFCS + | 65% CS + |
| | 65% CO | 35% CO | 50% CO | 65% CO | 35% CO | 50% CO | 35% FHCO |
| | (Blend 1) | (Blend 2) | (Blend 3) | (Blend 4) | (Blend 5) | (Blend 6) | (Blend 7) |
| SFC (%) at 10° C. | 51.1 | 28.1 | 63.2 | 47.1 | 33.4 | 49.5 | 44.2 |
| SFC (%) at 20° C. | 10.6 | 1.4 | 8.7 | 20.2 | 12.4 | 28.2 | 41.8 |
| SFC (%) at 30° C. | 0.2 | 0.1 | 0.5 | 0.1 | 1.4 | 5.4 | 24.5 |
| SFC (%) at 40° C. | 0.1 | 0.1 | 0.0 | 0.0 | 0.0 | 0.0 | 11.8 |
| Melting point, ° C. | 30.5 | 30.3 | 28.0 | 28.5 | 29.5 | 50.8 | 47.7 |
| FAP, C12:0, % | 29.0 | 15.3 | 22.0 | 29.3 | 15.3 | 0.0 | 0.05 |
| FAP, C16:0, % | 18.0 | 24.6 | 29.7 | 17.8 | 24.6 | 38.0 | 29.6 |
| FAP, C18:0, % | 3.1 | 2.7 | 2.6 | 3.1 | 2.7 | 24.4 | 27.0 |
| FAP, C18:1, % | 10.2 | 12.7 | 9.5 | 10.0 | 12.6 | 8.6 | 9.9 |
| FAP C18:2, % | 18.8 | 32.9 | 20.2 | 18.8 | 32.9 | 27.5 | 31.5 |
| FAP, C18:3, % | 0.1 | 0.1 | 0.1 | 0.1 | 0.2 | 0.1 | 0.1 |
| Saturated FA, % | 70.6 | 53.9 | 70.0 | 70.9 | 53.9 | 63.6 | 58.1 |

TABLE 3
Crystallization and melting profiles of fat blends determined
by differential scanning calorimetry (DSC)

| | Crystallization profile | | | | Melting profile | |
|---|---|---|---|---|---|---|
| | Onset | Peak 1 | Peak 2 | Enthalpy | Main | Enthalpy |
| Fat | (T° C.) | (T° C.) | (T° C.) | (J/g) | (T° C.) | (J/g) |
| Blend 35% CS + 65% CO | 6.6 | 5.0 | −10.9 | 76.2 | 18.8 | 90.4 |
| (Blend 1) | | | | | | |
| Blend 65% CS + 35% CO | 2.5 | 1.2 | −15.0 | 69.8 | 13.5 | 78.9 |
| (Blend 2) | | | | | | |
| Blend 50% DFCS + 50% CO | −3.7 | 0.8 | −7.1 | 80.7 | 15.5 | 91.9 |
| (Blend 3) | | | | | | |
| IE 35% CS + 65% CO | 12.8 | 4.7 | — | 95.1 | 24.0 | 105.8 |
| (Blend 4) | | | | | | |
| IE 65% CS + 35% CO | 16.0 | 12.4 | −0.3 | 84.0 | 18.2 | 94.9 |
| (Blend 5) | | | | | | |
| IE 50% DFCS + 50% CO | 12.5 | 5.7 | — | 90.9 | 27.5 | 100.4 |
| (Blend 6) | | | | | | |
| IE 65% CS + 35% FHCO | 32.2 | 30.3 | 11.8 | 80.4 | 45.5 | 88.7 |
| (Blend 7) | | | | | | |

### Example 2: Use of Fat Blends in an Icing Shortening

Fat blend 6 was used to make a non-palm icing shortening containing cotton stearin (CS or DFCS) using the formulation in Table 4. To make the icing, the shortening, sugar, vanilla, and salt were combined in a mixing bowl and mixed on low for one minute. Potassium sorbate was dissolved in water in a separate container. During the mixing, half of the water/potassium sorbate mixture was added. The mixer was stopped and the bowl was scraped. The mixing was resumed on low for 4 minutes. During the first 30 seconds of the 4 minutes of mixing, the remaining water/potassium sorbate mixture was added. The mixer was stopped, and the bowl was scraped. The mixing was resumed and continued until the target specific gravity of 0.8 was reached. The icing shortening had the properties to make icing or frosting (e.g., for cake decorating).

TABLE 4
Icing shortening formulation

| Ingredient | Wt % |
|---|---|
| Powdered sugar | 61.67 |
| Icing shortening | 28.46 |
| Water | 9.17 |
| Salt | 0.24 |
| Vanilla | 0.41 |
| Potassium sorbate | 0.05 |

### Example 3: Use of Fat Blends in an all-Purpose Shortening

Fat blend 7 was used to make a non-palm all-purpose shortening containing cotton stearin (CS or DFCS). To make the all-purpose shortening, the fat blend was melted, chilled, crystallized, and mechanically worked. To chill and crystallize the all-purpose shortening, a scraped surface heat exchanger (SSHE) was used. Pin rotor machines or intermediate crystallizers were used in combination or individually to performing the mechanical working, which were employed in order to ensure homogeneity. The product was a viable non-palm alternative for non-palm all-purpose shortening.

### Example 4: Use of Non-Palm all-Purpose Shortening to Make a Sugar Cookie

To make the sugar cookie, sugar, the all-purpose shortening of Ex. 3 and baking soda were combined in a mixer and mixed for about 30 s on low speed. The mixer was adjusted to second speed and continued mixing for 30 s. The mixer speed was adjusted to low, and all liquid ingredients (eggs, syrup, vanilla) were added and mixed for 1 min on low speed. The mixer was adjusted second speed and mixing continued for 30 s. The mixer speed was adjusted speed to low. Flour was added to the mixture and mixed for 1 min at low speed. The mixer was adjusted to second speed and mixing continued for 30 s. The resulting dough was scooped onto a cookie sheet in approximately 30 g allotments and baked in an oven at 375° F. for 11 min.

TABLE 5
Sugar Cookie formulation using
all-purpose shortening

| Ingredient | Wt % |
|---|---|
| Sugar | 29.28 |
| Non-Palm All-purpose | 15.57 |
| Shortening (Ex. 3) | |
| Oil | 3.00 |
| Salt | 0.50 |
| Baking soda | 0.67 |
| Whole eggs | 7.06 |
| Invert Syrup | 5.85 |
| Vanilla | 0.93 |
| Pastry flour | 18.57 |
| Cake flour | 18.57 |

### Example 5: Use of Fat Blends in Non-Dairy Creamer

Fat blends as described in Example 1 were used to prepare a non-dairy creamer. To make the non-dairy creamer, water was preheated to 120° F. Sugar and stabilizer were added to the warm water. The fat blend and polysorbate were then added to the water, and the mixture was heated to 150° F. and homogenized. The resulting product was added to a MicroThermics® batch tank and preheated to 180° F. The product was pasteurized to 280° F. and then vacuum cooled to 180° F. The product was homogenized at 2000 psi and cooled to 40° F. to obtain the non-dairy creamer.

TABLE 5
Non-Dairy Creamer formulation

| Ingredient | Wt % |
|---|---|
| Water | 59.23 |
| Sugar | 31.47 |
| Fat | 7.5 |
| Polysorbate | 0.2 |
| Stabilizer | 1.6 |

### Exemplary Aspects

The following exemplary aspects are provided, the numbering of which not to be construed as designating levels of importance:

Para. A. A composition comprising a fat blend, wherein the fat blend comprises cottonseed stearin, wherein the fat blend has a solid fat content (SFC) at 20° C. of about 1% to about 65%, a SFC at 30° C. of 0% to about 40%, and a SFC at 40° C. of 0% to 19.9%.

Para B. The composition of Para. A, wherein the fat blend has a SFC at 20° C. of about 1% to about 55%, a SFC at 30° C. of 0% to about 30%, and a SFC at 40° C. of 0% to about 18%.

Para. C. The composition of Para. A or Para. B, wherein the fat blend has a SFC at 20° C. of about 1% to about 45%, a SFC at 30° C. of 0% to about 25%, and a SFC at 40° C. of 0% to about 15%.

Para. D. The composition of any one of Paras. A-C, wherein the fat blend has a SFC at 20° C. of about 1% to about 35%, a SFC at 30° C. of 0% to about 15%, and a SFC at 40° C. of 0% to about 12%.

Para. E. The composition of any one of Paras. A-D, wherein the fat blend has a SFC at 20° C. of about 4% to about 22%, a SFC at 30° C. of 0% to about 7%, and a SFC at 40° C. of 0% to about 5%.

Para. F. The composition of any one of Paras. A-E, wherein the fat blend has a SFC at 10° C. of about 18% to about 70%.

Para. G. The composition of any one of Paras. A-F, wherein the fat blend has a SFC at 10° C. of about 20% to about 65%.

Para. H. The composition of any one of Paras. A-G, wherein the fat blend has a SFC at 10° C. of about 30% to about 60%.

Para. I. The composition of any one of Paras. A-H, wherein the fat blend has a SFC at 10° C. of about 30% to about 55%.

Para. J. The composition of any one of Paras. A-I, wherein the fat blend has a SFC at 10° C. of about 35% to about 55%.

Para. K. The composition of any one of Paras. A-J, wherein the cottonseed stearin comprises cottonseed stearin from a first fractionation, cottonseed stearin from a second fractionation, cottonseed stearin from more than a second fractionation, cottonseed stearin from one or more winterization fractionations, or a combination of two or more thereof.

Para. L. The composition of any one of Paras. A-K, wherein the fat blend is an interesterified fat blend.

Para. M. The composition of any one of Paras. A-L, wherein the interesterified fat blend is chemically interesterified.

Para. N. The composition of any one of Paras. A-M, wherein the interesterified fat blend is enzymatically interesterified.

Para. O. The composition of any one of Paras. A-N, wherein the composition is substantially free of palm oil.

Para. P. The composition of any one of Paras. A-O, wherein the fat blend has a main melting point below 40° C.

Para. Q. The composition of any one of Paras. A-P, wherein the fat blend comprises about 25 wt % to about 75 wt % of cottonseed stearin based on total weight of the fat blend.

Para. R. The composition of any one of Paras. A-Q, wherein the fat blend comprises about 25 wt % to about 45 wt % of cottonseed stearin based on total weight of the fat blend.

Para. S. The composition of any one of Paras. A-Q, wherein the fat blend comprises about 40 wt % to about 60 wt % of cottonseed stearin based on total weight of the fat blend.

Para. T. The composition of any one of Paras. A-Q, wherein the fat blend comprises about 55 wt % to about 75 wt % of cottonseed stearin based on total weight of the fat blend.

Para. U. The composition of any one of Paras. A-T, wherein about 0.01 wt % to 100 wt % of the composition is the fat blend.

Para. V. The composition of any one of Paras. A-U, wherein the fat blend further comprises a plant-based oil other than cottonseed stearin.

Para. W. The composition of any one of Paras. A-V, wherein the plant-based oils other than the cottonseed stearin comprise coconut oil, corn oil, canola oil, cottonseed oil, olive oil, peanut oil, rapeseed oil, safflower oil, sesame oil, soybean oil, sunflower oil, jojoba oil, cocoa butter, shea butter, mango butter, babassu oil, cupuassu oil, macauba oil, bacuri oil, tucuma oil, kokum oil, ucuuba oil, licuri oil, pequi oil, Illipe oil, a fraction thereof, a middle or high oleic version thereof, a low linolenic version thereof, a low saturated version thereof, a hydrogenated oil formed therefrom, an interesterified oil formed therefrom, or a combination or two or more thereof.

Para. X. The composition of any one of Paras. A-W, wherein the plant-based oil other than cottonseed stearin is present in an amount from 0.01 wt % to 99 wt % based on total weight of the fat blend.

Para. Y. The composition of any one of Paras. A-X, wherein the composition is substantially free of emulsifiers, non-cottonseed waxes, starch, protein, cellulose, cellulose derivatives, plant-based oils other than the cottonseed stearin, or a combination of two or more thereof.

Para. Z. The composition of any one of Paras. A-Y further comprises an emulsifier, a wax, a carbohydrate, a protein, cellulose, a cellulose derivative, a food coloring, a filler, a flavoring, an animal-based oil, or a combination of two or more thereof.

Para. AA. The composition of any one of Paras. A-Z, wherein the fat blend comprises 0 wt % to about 35 wt % C12:0 fatty acid, about 15 wt % to about 60 wt % C16:0 fatty acid, about 1 wt % to about 50 wt % C18:0 fatty acid, 5 wt % to about 20 wt % C18:1 fatty acid, about 10 wt % to about 40 wt % C18:2 fatty acid, 0 wt % to about 5 wt % C18:3 fatty acid, or a combination of two or more thereof.

Para. AB. The composition of any one of Paras. A-AA, wherein the fat blend is homogenous.

Para. AC. The composition of any one of Paras. A-AB, wherein the composition is a shortening, an all-purpose shortening, an icing shortening, a filling fat, a frying fat, a pumpable shortening, a cookie shortening, a cake shortening, a pastry shortening, a pie shortening, or a combination thereof.

Para. AD. A food item comprising the composition of any one of Paras. A-AC.

Para. AE. The food item of Para. AD, wherein the food item comprises a fried food item, a bakery food item, a biscuit filling, an icing, a frosting, a confectionary item, a bonbon filling, an ice-cream coating, a chocolate or nut spreads, a margarine or spread (water in oil emulsion), bouillon, or a combination of two or more thereof.

Para. AF. The food item of Para. AD or Para. AE, wherein the food item comprises a potato chip, a French fry, a fried-chicken product, a tempura product, a biscuit, a cookie, a pie, a cake, a wafer, a filling, a dough, a glaze, a pastry, a donut, an icing, a frosting, a pizza crust, an American style biscuit, a chewing gum, a meat alternative, a dairy analog product, ice cream, caramel, toffee, or a combination thereof.

Para. AG. The food item of Para. AD or Para. AE, wherein the food items comprises a fried food item, a biscuit filling, an icing, a frosting, a bonbon filling, or a combination of two or more thereof.

Para. AH. A method of making the composition of any one of Paras. A-AC, the method comprising combining cottonseed stearin and other edible components to form a homogenous mixture.

Para. AI. The method of Para. AH further comprising interesterifying the homogenous mixture.

Para. AJ. Use of the composition of any one of Paras. A-AC in partial or complete replacement of a fat in a food item and/or to form the food item.

### EQUIVALENTS

While certain aspects have been illustrated and described, a person with ordinary skill in the art, after reading the foregoing specification, can effect changes, substitutions of equivalents and other types of alterations to the nanoparticles of the present technology or derivatives, prodrugs, or pharmaceutical compositions thereof as set forth herein. Each aspect and aspect described above can also have included or incorporated therewith such variations or aspects as disclosed in regard to any or all of the other aspects and aspects.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Likewise, the use of the terms “comprising,” “including,” “containing,” etc. shall be understood to disclose aspects using the terms “consisting essentially of” and “consisting of” and vice versa. The phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether or not the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other aspects are set forth in the following claims, along with the full scope of equivalents to which such claims are entitled.

1. A composition comprising a fat blend, wherein the fat blend comprises cottonseed stearin, wherein the fat blend has a solid fat content (SFC) at 20° C. of about 1% to about 65%, a SFC at 30° C. of 0% to about 40%, and a SFC at 40° C. of 0% to 19.9%.

2. The composition of claim 1, wherein the fat blend has a SFC at 20° C. of about 1% to about 55%, a SFC at 30° C. of 0% to about 30%, and a SFC at 40° C. of 0% to about 18%.

3. The composition of claim 1, wherein the fat blend has a SFC at 20° C. of about 1% to about 45%, a SFC at 30° C. of 0% to about 25%, and a SFC at 40° C. of 0% to about 15%.

4. The composition of claim 1, wherein the fat blend has a SFC at 20° C. of about 1% to about 35%, a SFC at 30° C. of 0% to about 15%, and a SFC at 40° C. of 0% to about 12%.

5. The composition of claim 1, wherein the fat blend has a SFC at 20° C. of about 4% to about 22%, a SFC at 30° C. of 0% to about 7%, and a SFC at 40° C. of 0% to about 5%.

6. The composition of claim 1, wherein the fat blend has a SFC at 10° C. of about 18% to about 70%.

7-10. (canceled)

11. The composition of claim 1, wherein the cottonseed stearin comprises cottonseed stearin from a first fractionation, cottonseed stearin from a second fractionation, cottonseed stearin from more than a second fractionation, cottonseed stearin from one or more winterization fractionations, or a combination of two or more thereof.

12. The composition of claim 1, wherein the fat blend is an interesterified fat blend.

13-14. (canceled)

15. The composition of claim 1, wherein the composition is substantially free of palm oil.

16. The composition of claim 1, wherein the fat blend has a main melting point below 40° C.

17. The composition of claim 1, wherein the fat blend comprises about 25 wt % to about 75 wt % of cottonseed stearin based on total weight of the fat blend.

18-20. (canceled)

21. The composition of claim 1, wherein about 0.01 wt % to 100 wt % of the composition is the fat blend.

22. The composition of claim 1, wherein the fat blend further comprises a plant-based oil other than cottonseed stearin.

23. The composition of claim 22, wherein the plant-based oils other than the cottonseed stearin comprise coconut oil, corn oil, canola oil, cottonseed oil, olive oil, peanut oil, rapeseed oil, safflower oil, sesame oil, soybean oil, sunflower oil, jojoba oil, cocoa butter, shea butter, mango butter, babassu oil, cupuassu oil, macauba oil, bacuri oil, tucuma oil, kokum oil, ucuuba oil, licuri oil, pequi oil, Illipe oil, a fraction thereof, a middle or high oleic version thereof, a low linolenic version thereof, a low saturated version thereof, a hydrogenated oil formed therefrom, an interesterified oil formed therefrom, or a combination or two or more thereof.

24. The composition of claim 22, wherein the plant-based oil other than cottonseed stearin is present in an amount from 0.01 wt % to 99 wt % based on total weight of the fat blend.

25-26. (canceled)

27. The composition of claim 1, wherein the fat blend comprises 0 wt % to about 35 wt % C12:0 fatty acid, about 15 wt % to about 60 wt % C16:0 fatty acid, about 1 wt % to about 50 wt % C18:0 fatty acid, 5 wt % to about 20 wt % C18:1 fatty acid, about 10 wt % to about 40 wt % C18:2 fatty acid, 0 wt % to about 5 wt % C18:3 fatty acid, or a combination of two or more thereof.

28. (canceled)

29. The composition of claim 1, wherein the composition is a shortening, an all-purpose shortening, an icing shortening, a filling fat, a frying fat, a pumpable shortening, a cookie shortening, a cake shortening, a pastry shortening, a pie shortening, or a combination thereof.

30. A food item comprising the composition of claim 1.

31. The food item of claim 30, wherein the food item comprises a fried food item, a bakery food item, a biscuit filling, an icing, a frosting, a confectionary item, a bonbon filling, an ice-cream coating, a chocolate or nut spreads, a margarine or spread (water in oil emulsion), bouillon, or a combination of two or more thereof.

32-33. (canceled)

34. A method of making the composition of claim 1, the method comprising combining cottonseed stearin and other edible components to form a homogenous mixture; and optionally interesterifying the homogenous mixture.

35-36. (canceled)
